(19) United States
(12) Patent Application Publication
(10) Pub. No.: US 2013/0186987 A1
(43) Pub. Date: Jul. 25, 2013

(54) GRAPHITE NOZZLE FOR POLYSILICON REFINING CYCLIC VACUUM EQUIPMENT

(71) Applicant: SUN POWER SILICON CO., LTD., TAIPEI CITY (TW)

(72) Inventor: WEN-PIN SUN, Taichung City (TW)

(73) Assignee: SUN POWER SILICON CO., LTD., TAIPEI CITY (TW)

(21) Appl. No.: 13/741,385

(22) Filed: Jan. 15, 2013

(30) Foreign Application Priority Data
Jan. 20, 2012 (TW) 101102334

(51) Int. Cl. B05B 1/00

(52) U.S. Cl. CPC B05B 1/00
USPC 239/589; 156/296

(57) ABSTRACT

A graphite nozzle is combined by stacking a plurality of graphite tubes together, applied in polysilicon refining cyclic vacuum equipment or used as a lining of fireproof or refractory material, where each graphite tube includes a upper coupling portion and a lower coupling portion, the upper coupling portion is positioned on a top face of a upper side of the graphite tube; and the lower coupling portion is positioned on a bottom face of a lower side of the graphite tube, and corresponds to the upper coupling portion, allowing the upper coupling portion of each graphite tube to be propped against the lower coupling portion of another graphite tube; the graphite tubes are fused and coupled together by means of a sintering treatment after the graphite tubes are stacked together.

### TECHNICAL FIELD OF THE INVENTION

The present invention relates to a graphite nozzle used for polysilicon refining cyclic vacuum equipment.

### DESCRIPTION OF THE PRIOR ART

Taiwan Patent application No. 100138537 (application date: Oct. 24, 2011) proposed by the applicant of the present invention discloses a technology and apparatus for refining solar-grade polysilicon by means of vacuum circulation, combining a RH (Rubrstahl/Heracus) furnace with VD (vacuum degassing) furnace to from an apparatus for refining solar-grade polysilicon by means of simplex-nozzle double vacuum circulation, and utilizing the vacuum stirring, diffusion and deoxidation of this apparatus to prepare solar-grade polysilicon. The apparatus for refining solar-grade polysilicon by means of simplex-nozzle double vacuum circulation includes a high vacuum room of the RH furnace at the upper side and a low vacuum room of the VD furnace(or combined intermediate frequency furnace) at the lower side, which is connected to each other through a simplex nozzle communication tube(round tube suction nozzle).

RH furnace is also referred to as cyclic vacuum furnace, developed jointly by two German companies, Rubrstahl and Heracus. The main operation method thereof is driving steel fluid to rise to a definite height after evacuation by inserting two conduits disposed on the lower side of a vacuum room into steel fluid, and then blowing in inert gas Ar via a riser tube to drive the steel fluid to enter the vacuum room for the acceptance of a vacuum treatment, and thereafter flowing it back to a ladle via another descending conduit. This method has become the main vacuum treatment method of steel fluid in advanced steel factories. However, lined nozzles in conduits used in steelmaking mostly are made of alumina, quartz (silicon oxide), ceramic, or other refractory material containing magnesium or boron. But, these materials are not suitable to be adopted as nozzles used in solar-grade polysilicon refining cyclic vacuum equipment (RH furnace).

### SUMMARY OF THE INVENTION

To be not subject to the influence of conduit material during refinement, the present invention provide a graphite nozzle for polysilicon refining cyclic equipment, preventing the chemical reaction between foreign material and silicon, and capable of being used directly as communicating conduit lining and other linings in high-density refractory graphite tubes in solar-grade polysilicon vacuum cyclic refining apparatus (RH cyclic vacuum furnace).

A graphite nozzle of the present invention is constituted by stacking a plurality of graphite tubes together, where each graphite tube includes a upper coupling portion and lower coupling portion, where the upper coupling portion is positioned on the top face of the upper side of the graphite tube, and lower coupling portion is positioned on the bottom face of the lower side of the graphite tube and corresponds to the upper coupling portion, allowing the upper coupling portion of each graphite tube to be propped against the lower coupling portion of another graphite tube, and each graphite tube to be fused with and coupled closely to another graphite tube by means of a sintering treatment after each two graphite tubes are stacked together.

Furthermore, for the stability of the relative positions of each two adjacent graphite tubes, various corresponding patterns of the upper and lower coupling portions are further provided, thereby improving the assembly convenience.

Furthermore, the present invention allows the distance between the upper coupling portion of each graphite tube and the lower coupling portion of another graphite tube is smaller than 5 mm, benefiting capable of improving the subsequent processing and the stability after the completion of sintering.

Furthermore, the present invention may allow pitch, tar, carbon glue, carbon paste, carbon and water (carbon mud), carbon dust, silicone, silicon paste, silicon water (mud) of silicon (Si), pozzolan or water may further be added in between each two adjacent graphite tubes, thereby having a temporary assistant positioning effect.

Furthermore, preferably, each graphite tube of the present embodiment is formed of a core removing graphite body, convenient for manufacturing.

### BRIEF DESCRIPTION OF THE DRAWINGS

FIG. 1 is a cross sectional view of a preferred embodiment according to the present invention; and

FIGS. 2 to 13 are partly enlarged views of the embodiment according to the present invention.

### DETAILED DESCRIPTION OF THE PREFERRED EMBODIMENTS

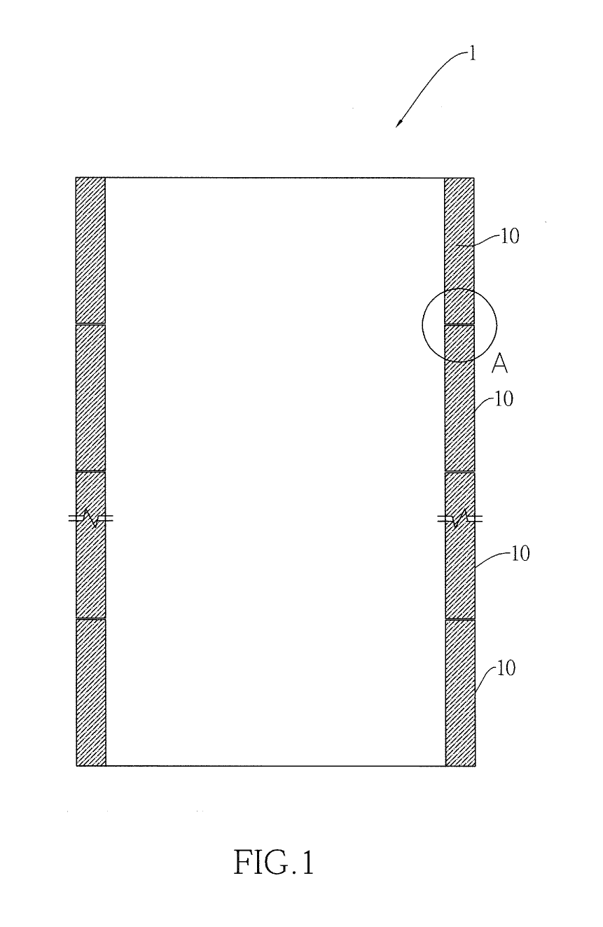

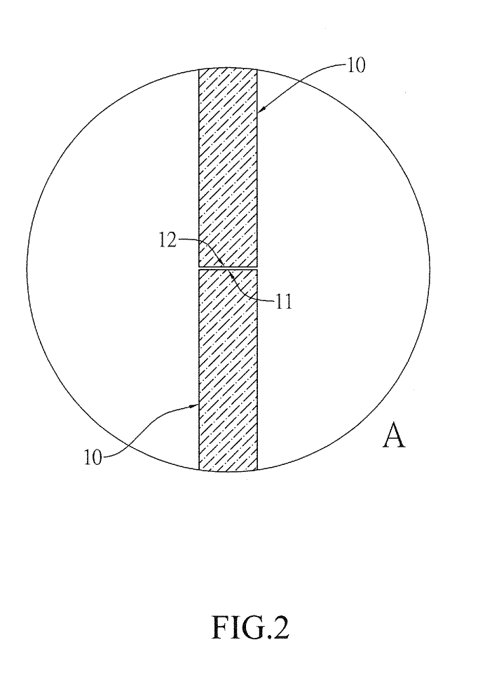

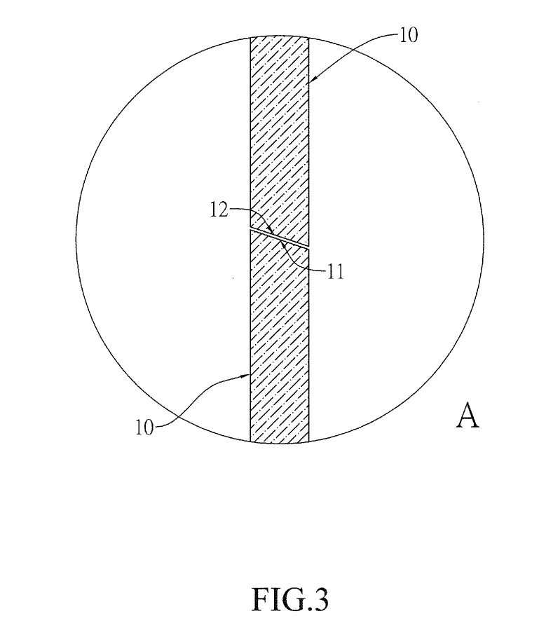

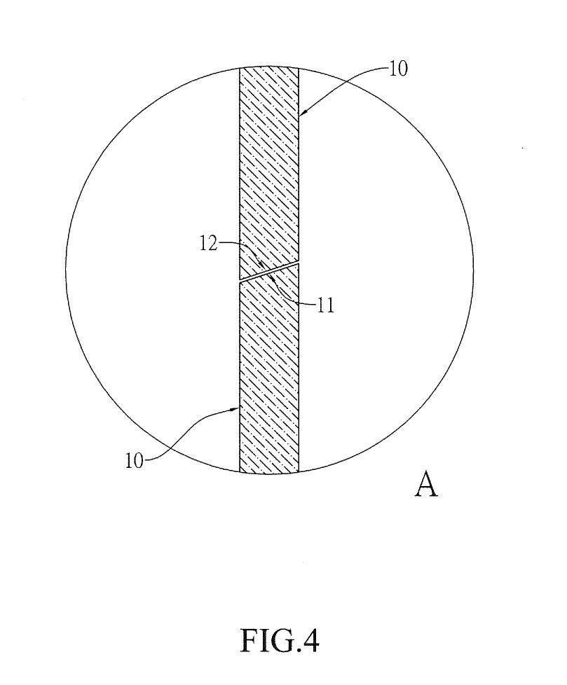

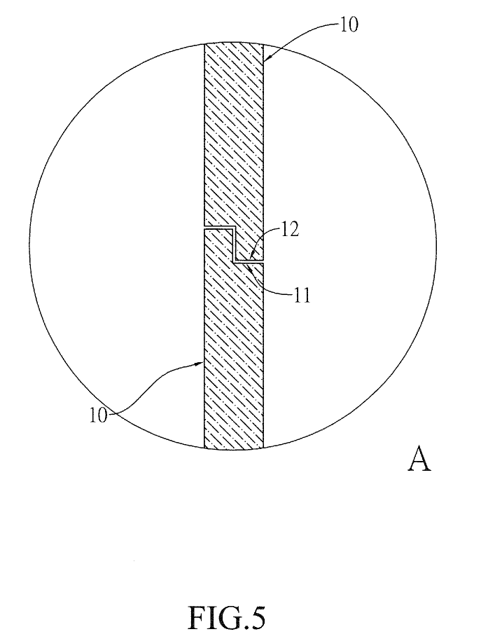

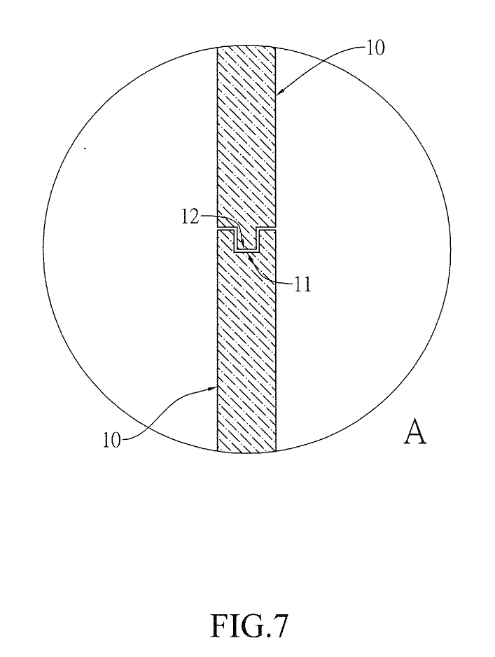

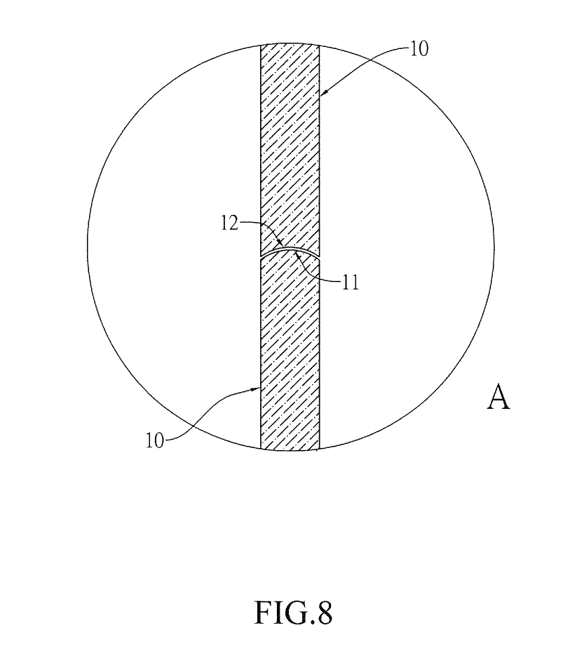

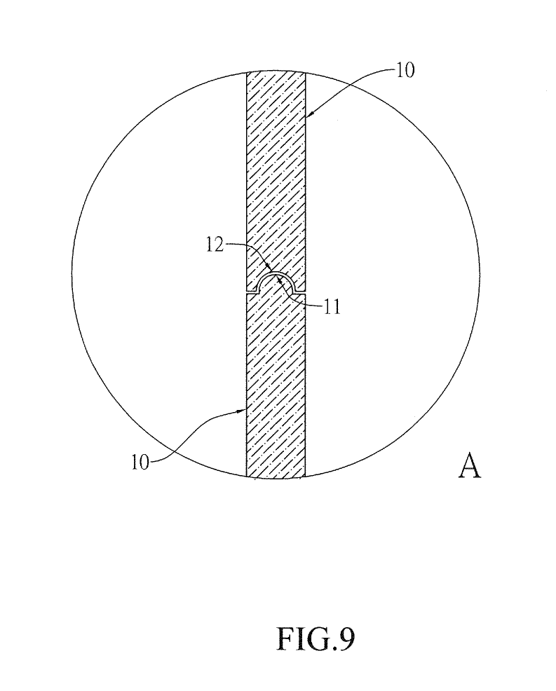

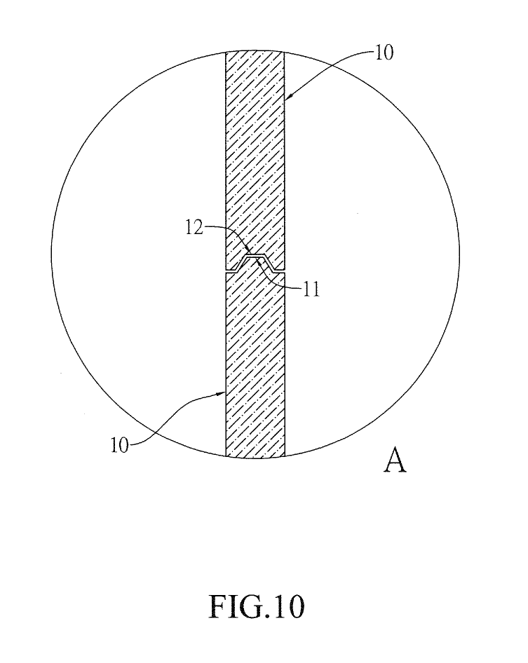

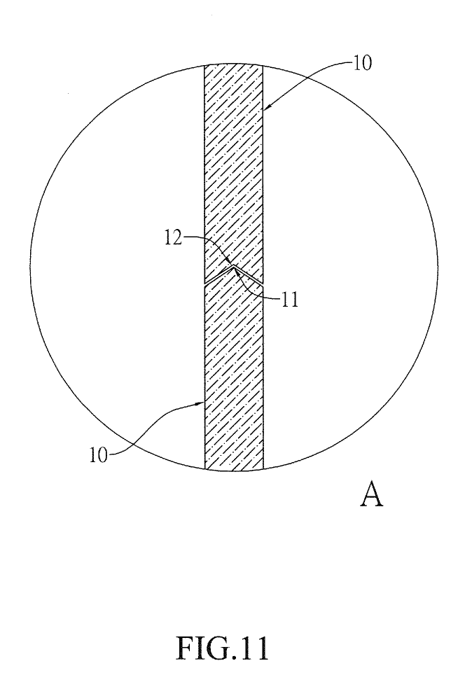

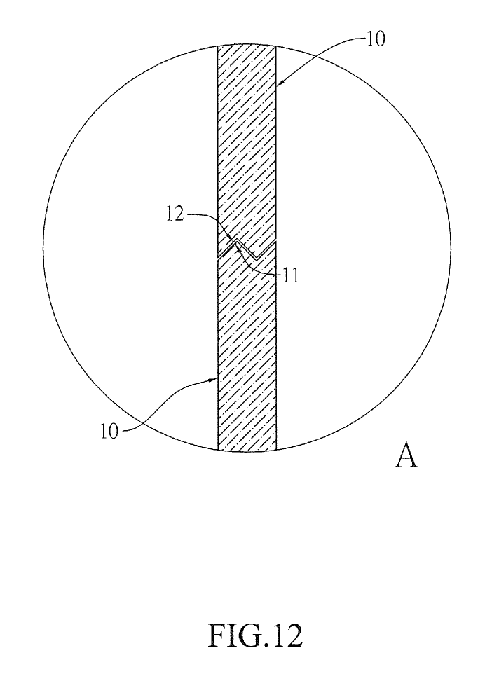

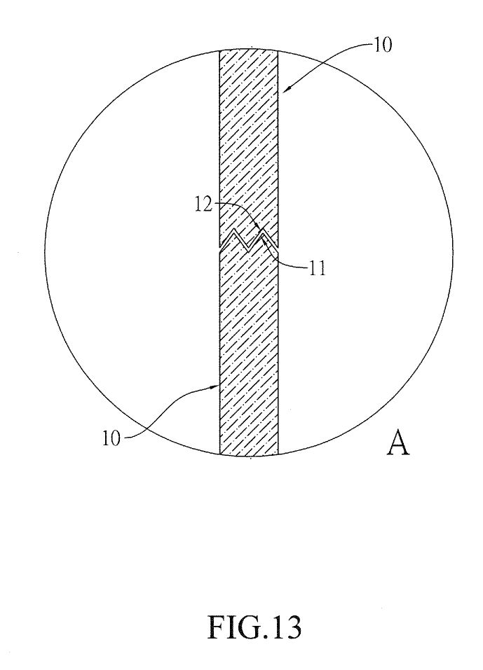

Referring to FIG. 1 to 13. FIG. 1 is a cross sectional view, illustrating a graphite nozzle for polysilicon refining cyclic vacuum equipment, and FIGS. 2 to 13 are partly enlarged views.

A graphite nozzle 1 for polysilicon refining cyclic vacuum equipment is constituted by stacking a plurality of graphite tubes 10 together, where each graphite tube 10 includes a upper coupling portion 11 and a lower coupling portion 12, where the upper coupling portion 11 is positioned on the top face of the upper side of the graphite tube 10, and the lower coupling portion 12 on the bottom face of the lower side of the graphite tube 10 and corresponds to the upper coupling portion 11, allowing the upper coupling portion 11 of each graphite tube 10 to be propped against the lower coupling portion 12 of the another graphite tube 10, and the two adjacent graphite tubes 10 to be fused and coupled closely together by means of a sintering treatment after the graphite tubes 10 are stacked together.

The present embodiment prevents the chemical reaction between foreign material and silicon, capable of being used directly as communicating conduit lining and other linings in high-density refractory graphite tubes in solar-grade polysilicon vacuum cyclic refining apparatus(RH cyclic vacuum furnace), thereby improving polysilicon refining stability.

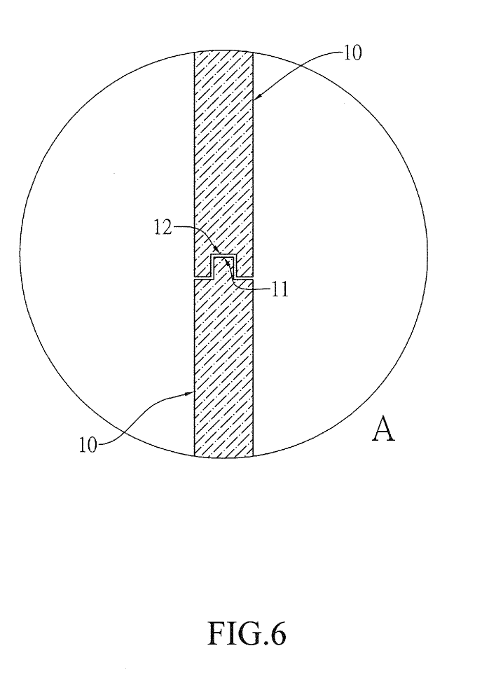

Furthermore, to improve the stability of each graphite tube 10 in abutting assembly, the embodiment provides various types of upper and lower coupling portions. Referring to FIGS. 2 to 13, the upper coupling portion 11 is a flat plane and the lower coupling portion 12 a corresponding flat plane, the upper coupling portion 11 is an inclined plane inclined upward from outside to inside and the lower coupling portion 12 is also an inclined plane inclined upward from outside to inside as FIG. 6 shows. Otherwise, the upper coupling portion 11 is an inclined plane inclined downward from outside to inside and the lower coupling portion 12 is also an inclined plane inclined downward from outside to inside.

In addition, the upper coupling portion 11 may be a bump and the lower coupling portion 12 is a corresponding recess, or the upper coupling portion 11 is a recess and the lower coupling portion 12 is a corresponding bump. Furthermore, the bump may have an inclined face or curved face.

The relative position of each graphite tube 10 can be stabilized before and during sintering through the various types of the upper and lower coupling portions 11, 12 shown in FIGS. 2 to 13, thereby improving the yield after sintering.

Furthermore, the distance between the upper coupling portion 11 of each graphite tube 10 and the lower coupling portion 12 of another graphite tube 10 is smaller than 3 mm during coupling abutting, thereby facilitating carrying out sintering.

Furthermore, pitch, tar, carbon glue, carbon paste, carbon and water (carbon mud), carbon dust, silicone, silicon paste, silicon water (mud) of silicon (Si), pozzolan or water may be added in between each two adjacent graphite tubes 10, used as a consolation adhesive, capable of stabilizing the relative position of each two adjacent graphite tubes 10 temporarily before the sintering is carried out.

In addition, the graphite tube 10 may be formed of a core removing cylinder, thereby improving the stability of the graphite tube,

From the description mentioned above, the present invention utilizes a plurality of graphite tubes 10 to manufacture the graphite nozzle 1, which a dimension or shape design may be carried out depending on requirements to ensure the stability of entirety, facilitating the use for communicating conduit lining or other linings in refractory tubes.

I claim:

1. A graphite nozzle for polysilicon refining cyclic vacuum equipment, combined by stacking a plurality of graphite tubes together, each said graphite tube comprising:
a upper coupling portion, positioned on a top face of a upper side of said graphite tube; and
a lower coupling portion, positioned on a bottom face of a lower side of said graphite tube, and corresponding to said upper coupling portion, allowing said upper coupling portion of each said graphite tube to be propped against said lower coupling portion of another graphite tube;
wherein said graphite tubes are fused and coupled together by means of a sintering treatment after said graphite tubes are stacked together.

2. The graphite nozzle according to claim 1, wherein said upper coupling portion is a flat plane and said lower coupling portion is a corresponding flat plane, or said coupling portion is an inclined plane inclined upward from outside to inside and said lower coupling portion is an inclined plane inclined upward from outside to inside, or, said upper coupling portion is an inclined plane inclined downward from outside to inside and said lower coupling portion is also an inclined plane inclined downward from outside to inside.

3. The graphite nozzle according to claim 1, wherein said upper coupling portion is a bump and said lower coupling portion is a corresponding recess, or, said upper coupling portion is a recess and said lower coupling portion is a corresponding bump.

4. The graphite nozzle according to claim 3, wherein said bump has an inclined or curved face.

5. The graphite nozzle according to claim 2, wherein a distance between said upper coupling portion of each said graphite tube and said lower coupling portion of another said graphite tube is smaller than 5 mm.

6. The graphite nozzle according to claim 4, wherein a distance between said upper coupling portion of each said graphite tube and said lower coupling portion of another said graphite tube is smaller than 5 mm.

7. The graphite nozzle according to claim 1, wherein pitch, tar, carbon glue, carbon paste, carbon and water (carbon mud), carbon dust, silicone, silicon paste, silicon water (mud) of silicon (Si), pozzolan or water is added in between each two said adjacent graphite tubes.

8. The graphite nozzle according to claim 1, wherein said graphite is formed of a core-removing cylinder silicon (Si), pozzolan or water is added in between each two said adjacent graphite tubes.
